(19) United States
(12) Patent Application Publication
(10) Pub. No.: US 2023/0290290 A1
(43) Pub. Date: Sep. 14, 2023

(54) Systems and Methods for Real-Time Color Correction of Waveguide Based Displays

(71) Applicant: DigiLens Inc., Sunnyvale, CA (US)

(72) Inventors: Nima Shams, Sunnyvale, CA (US); Nicholas Sherwood, Sunnyvale, CA (US); Milan Momcilo Popovich, Leicester (GB); Alastair John Grant, San Jose, CA (US)

(73) Assignee: DigiLens Inc., Sunnyvale, CA (US)

(21) Appl. No.: 18/002,847

(22) PCT Filed: Jun. 22, 2021
(86) PCT No.: PCT/US2021/038542

§ 371 Date: Dec. 21, 2022

Related U.S. Application Data
(60) Provisional application No. 63/042,398, filed on Jun. 22, 2020.

(51) Int. Cl. G09G 3/20; G02B 5/18; G02B 27/01

(52) U.S. Cl. CPC G09G 3/2003; G02B 5/1814; G02B 27/0172; G09G 2360/145

(57) ABSTRACT

Systems and methods for real-time color correction of waveguide-based displays are disclosed herein. In some embodiments, a color correction system is included. The color correction system may include a light source, a detector, and a waveguide. The waveguide includes an input grating to inputting illumination light from the light source into the waveguide; an illumination grating for deflecting the illumination light towards an eye; a detector grating to input illumination light reflected off the eye into the waveguide; and an output grating for outputting the reflected illumination light from the waveguide into the detector.

### CROSS REFERENCE TO RELATED APPLICATIONS

This current application is a U.S. National Stage Patent Application of PCT Patent Application No. PCT/US2021/038542 entitled “Systems and Methods for Real-Time Color Correction Of Waveguide Based Displays,” filed Jun. 22, 2021, which claims the benefit of priority to U.S. Provisional Patent Application No. 63/042,398 entitled “Systems and Methods for Real-Time Color Correction for Waveguide Displays and Related Applications,” filed Jun. 22, 2020. The disclosure of the provisional patent application is hereby incorporated by reference in its entirety for all purposes.

### FIELD OF THE INVENTION

The present invention generally relates to color correction for waveguides and, more specifically, to real-time color correction for waveguide applications.

### BACKGROUND

Waveguides can be referred to as structures with the capability of confining and guiding waves (e.g., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (TIR).

Fabrication of waveguides can include the use of material systems that allow for the recording of holographic optical elements within the waveguides. One class of such material includes polymer dispersed liquid crystal (PDLC) mixtures, which are mixtures containing photopolymerizable monomers and liquid crystals. A further subclass of such mixtures includes holographic polymer dispersed liquid crystal (HPDLC) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating. The resulting grating, which is commonly referred to as a switchable Bragg grating (SBG), has all the properties normally associated with volume or Bragg gratings but with much higher refractive index modulation ranges combined with the ability to electrically tune the grating over a continuous range of diffraction efficiency (the proportion of incident light diffracted into a desired direction). The latter can extend from non-diffracting (cleared) to diffracting with close to 100% efficiency.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (AR) and virtual reality (VR), compact head-up displays (HUDs) and helmet-mounted displays or head-mounted displays (HMDs) for road transport, aviation, and military applications, and sensors for biometric and laser radar (LIDAR) applications.

### SUMMARY OF THE DISCLOSURE

Various embodiments are directed to a color correction system including: an eye tracker system; and an optical engine controller in communication with the eye tracker system and an optical engine, where the eye tracker system is configured to compute eye gaze direction vectors and eye pupil coordinates, and where the optical engine controller is configured to compute a compensation factor based on the eye gaze direction vectors and the eye pupil coordinates.

In various other embodiments, the eye tracker system includes: a light source; a detector; a waveguide comprising: an input grating to inputting illumination light from the light source into the waveguide; an illumination grating for deflecting the illumination light towards an eye; an detector grating to input illumination light reflected off the eye into the waveguide; and an output grating for outputting the reflected illumination light from the waveguide into the detector, wherein the detector is configured to compute the eye gaze direction vectors and the eye pupil coordinates based on reflected illumination light.

In still various other embodiments, the illumination grating and/or the imaging grating includes an array of switchable beam deflection grating elements.

In still various other embodiments, the array of switchable beam deflection grating elements includes grating elements elongated with a longer dimension orthogonal to a beam propagation direction of the illumination light.

In still various other embodiments, the array of switchable beam deflection grating elements includes grating elements disposed in a two-dimensional array.

In still various other embodiments, each grating element is configured to have optical power in two orthogonal planes.

In still various other embodiments, the illumination grating and the imaging grating comprises a single grating configured to both deflect the illumination light towards the eye and input illumination light reflected off the eye into the waveguide.

In still various other embodiments, the illumination grating and the imaging grating include separate gratings in separate layers.

In still various other embodiments, the illumination grating and the input grating are in a first grating layer and the imaging grating and the output grating are in a second grating layer.

In still various other embodiments, the first grating layer and second grating layer are separate grating layers and are each sandwiched by substrate forming two distinct waveguiding structures.

In still various other embodiments, the illumination grating and the imaging grating respond to different total internal reflection angle ranges within the waveguide.

In still various other embodiments, the illumination light is reflected off the front surface of the cornea, the lens, and/or the retina of the eye.

In still various other embodiments, the illumination light includes infrared light.

In still various other embodiments, the optical engine controller uses a look-up table to compute the compensation factor.

In still various other embodiments, the look-up table correlates different gaze directions and pupil coordinates of the user's eye with different image compensation factors.

In still various other embodiments, the compensation factor includes color correction or image correction.

In still various other embodiments, the detector includes a detector signal processor which is configured to compute the eye gaze direction vectors and the eye pupil coordinates from the detected illumination light.

Further, various embodiments are directed to a waveguide-based display including: the color correction system as disclosed above; and another waveguide configured to accept light from the optical engine and output the light into the user's eye.

In various other embodiments, the waveguide and the other waveguide are in contact with each other.

In still various other embodiments, the waveguide and the other waveguide are separated by an air gap or a low reflective material.

Further, various embodiments are directed to a method of providing real-time color correction for a waveguide based display, the method including: transmitting a light pattern onto a user's eye; reflecting the light pattern off of a feature of the user's eye; directing the reflected light pattern towards a detector to produce eye tracking information, wherein the eye tracking information comprises eye gaze direction vectors and eye pupil coordinates; determining the user's viewing condition based on the eye tracking information; based on the determined viewing condition, applying a compensation factor to an input image light.

In various other embodiments, the feature of the user's eye includes the lens, the cornea, or the retina of the user's eye.

In still various other embodiments, compensation factor includes compensation to an input image to a waveguide.

In still various other embodiments, the compensation factor is used to alter an input image originating from an optical engine.

In still various other embodiments, the compensation factor is applied with frequency that is equal to or less than the operating frequency of the detector.

In still various other embodiments, the compensation factor includes color correction or image correction.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIG. 1 illustrates an eye tracker waveguide solution in accordance with an embodiment of the invention.

FIG. 2 illustrates an example diagram of eye pupil translation.

FIG. 3 illustrates an array design of a grating with elongated elements in accordance with an embodiment of the invention.

FIG. 4 illustrates an array design of a grating with elements disposed in a two-dimensional array in accordance with an embodiment of the invention.

FIG. 5 illustrates a schematic of a waveguide display implementing real-time color correction in accordance with an embodiment of the invention.

FIG. 6 is a flow chart illustrating a process for real-time color correction for waveguide applications in accordance with an embodiment of the invention.

### DETAILED DESCRIPTION

For the purposes of describing embodiments, some well-known features of optical technology known to those skilled in the art of optical design and visual displays have been omitted or simplified in order to not obscure the basic principles of the invention. Unless otherwise stated, the term “on-axis” in relation to a ray or a beam direction refers to propagation parallel to an axis normal to the surfaces of the optical components described in relation to the invention. In the following description the terms light, ray, beam, and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. As used herein, the term grating may encompass a grating comprised of a set of gratings in some embodiments. For illustrative purposes, it is to be understood that the drawings and figures are not drawn to scale unless stated otherwise.

Optical waveguides utilizing nanoscale optical features can be implemented to provide transparent displays for various applications. In many display applications, it would be ideal that every pixel rendered with the same color (RGB) value would look identical in the output of the waveguide. In practice, brightness, contrast, color, and other properties can vary in the output due to certain limitations that can depend on the grating design. For example, one common issue in the field of waveguide displays is color non-uniformity in the final output image. Furthermore, such problems can be compounded as these properties can also vary depending on the user's viewing conditions. In many cases, these variations can be minimized or corrected for during processing and/or by optimizing the waveguide design. Correction during processing can be implemented by pre-calibrating the waveguide by measuring the output image and then altering the input image light to compensate for the variations. However, addressing non-uniformity issues that vary based on the user's viewing conditions during processing can be difficult or impossible since correcting for one viewing condition may affect another. As such, many embodiments of the invention are directed towards resolving or mitigating the issue of color non-uniformity in waveguides in real-time based on the user's viewing condition. Real-time color correction systems and methods in accordance with various embodiments of the invention can be utilized as appropriate with a variety of different waveguides for various applications, including but not limited to waveguide displays. Real-time color correction systems and methods may also be used to mitigate other types of photometric nonuniformity in real time based on the user's viewing condition. For example, luminance non-uniformity and contrast non-uniformity may be mitigated.

In many embodiments, the correction system utilizes one or more eye trackers to determine the user's viewing condition to provide an appropriate real-time correction or compensation to the output image. The information can be conveyed to a controller, which can send signals to the projection system to project the corrected image. As can readily be appreciated, various types of eye trackers along with algorithms for implementing such tools can be utilized as appropriate depending on the specific requirements of a given application. In some embodiments, the eye tracker utilizes a projector for projecting a known pattern of light onto the eye. Reflections and changes in the reflections can be used to infer eye rotation, pupil location, and other ocular information. In some embodiments, features of the eyes are tracked over time to infer eye rotation through changes in the reflections. In many embodiments, cameras and optical sensors are utilized to sense light, typically infrared, that is reflected from the eye to implement eye tracking. Waveguides, waveguide displays, optical structures and configurations, eye tracking solutions, and systems and methods for real-time color correction are described below in further detail.

### Optical Waveguide and Grating Structures

Optical structures recorded in waveguides can include many different types of optical elements, such as but not limited to diffraction gratings. Gratings can be implemented to perform various optical functions, including but not limited to coupling light, directing light, and preventing the transmission of light. In many embodiments, the gratings are surface relief gratings that reside on the outer surface of the waveguide. In other embodiments, the grating implemented is a Bragg grating (also referred to as a volume grating), which are structures having a periodic refractive index modulation. Bragg gratings can be fabricated using a variety of different methods. One process includes interferential exposure of holographic photopolymer materials to form periodic structures. Bragg gratings can have high efficiency with little light being diffracted into higher orders. The relative amount of light in the diffracted and zero order can be varied by controlling the refractive index modulation of the grating, a property that can be used to make lossy waveguide gratings for extracting light over a large pupil.

One class of Bragg gratings used in holographic waveguide devices is the Switchable Bragg Grating (SBG). SBGs can be fabricated by first placing a thin film of a mixture of photopolymerizable monomers and liquid crystal material between substrates. The substrates can be made of various types of materials, such glass and plastics. In many cases, the substrates are in a parallel configuration. In other embodiments, the substrates form a wedge shape. One or both substrates can support electrodes, typically transparent tin oxide films, for applying an electric field across the film. The grating structure in an SBG can be recorded in the liquid material (often referred to as the syrup) through photopolymerization-induced phase separation using interferential exposure with a spatially periodic intensity modulation. Factors such as but not limited to control of the irradiation intensity, component volume fractions of the materials in the mixture, and exposure temperature can determine the resulting grating morphology and performance. As can readily be appreciated, a wide variety of materials and mixtures can be used depending on the specific requirements of a given application. In many embodiments, HPDLC material is used. During the recording process, the monomers polymerize, and the mixture undergoes a phase separation. The LC molecules aggregate to form discrete or coalesced droplets that are periodically distributed in polymer networks on the scale of optical wavelengths. The alternating liquid crystal-rich and liquid crystal-depleted regions form the fringe planes of the grating, which can produce Bragg diffraction with a strong optical polarization resulting from the orientation ordering of the LC molecules in the droplets.

The resulting volume phase grating can exhibit very high diffraction efficiency, which can be controlled by the magnitude of the electric field applied across the film. When an electric field is applied to the grating via transparent electrodes, the natural orientation of the LC droplets can change, causing the refractive index modulation of the fringes to lower and the hologram diffraction efficiency to drop to very low levels. Typically, the electrodes are configured such that the applied electric field will be perpendicular to the substrates. In a number of embodiments, the electrodes are fabricated from indium tin oxide (ITO). In the OFF state with no electric field applied, the extraordinary axis of the liquid crystals generally aligns normal to the fringes. The grating thus exhibits high refractive index modulation and high diffraction efficiency for P-polarized light. When an electric field is applied to the HPDLC, the grating switches to the ON state wherein the extraordinary axes of the liquid crystal molecules align parallel to the applied field and hence perpendicular to the substrate. In the ON state, the grating exhibits lower refractive index modulation and lower diffraction efficiency for both S- and P-polarized light. Thus, the grating region no longer diffracts light. Each grating region can be divided into a multiplicity of grating elements such as for example a pixel matrix according to the function of the HPDLC device. Typically, the electrode on one substrate surface is uniform and continuous, while electrodes on the opposing substrate surface are patterned in accordance to the multiplicity of selectively switchable grating elements.

Typically, the SBG elements are switched clear in 30 μs with a longer relaxation time to switch ON. The diffraction efficiency of the device can be adjusted, by means of the applied voltage, over a continuous range. In many cases, the device exhibits near 100% efficiency with no voltage applied and essentially zero efficiency with a sufficiently high voltage applied. In certain types of HPDLC devices, magnetic fields can be used to control the LC orientation. In some HPDLC applications, phase separation of the LC material from the polymer can be accomplished to such a degree that no discernible droplet structure results. An SBG can also be used as a passive grating. In this mode, its chief benefit is a uniquely high refractive index modulation. SBGs can be used to provide transmission or reflection gratings for free space applications. SBGs can be implemented as waveguide devices in which the HPDLC forms either the waveguide core or an evanescently coupled layer in proximity to the waveguide. The substrates used to form the HPDLC cell provide a total internal reflection (TIR) light guiding structure. Light can be coupled out of the SBG when the switchable grating diffracts the light at an angle beyond the TIR condition.

In some embodiments, LC can be extracted or evacuated from the SBG to provide an evacuated Bragg grating (EBG). EBGs can be characterized as a surface relief grating (SRG) that has properties very similar to a Bragg grating due to the depth of the SRG structure (which is much greater than that practically achievable using surface etching and other conventional processes commonly used to fabricate SRGs). The LC can be extracted using a variety of different methods, including but not limited to flushing with isopropyl alcohol and solvents. In many embodiments, one of the transparent substrates of the SBG is removed, and the LC is extracted. In further embodiments, the removed substrate is replaced. The SRG can be at least partially backfilled with a material of higher or lower refractive index. Such gratings offer scope for tailoring the efficiency, angular/spectral response, polarization, and other properties to suit various waveguide applications.

Waveguides in accordance with various embodiments of the invention can include various grating configurations designed for specific purposes and functions. In many embodiments, the waveguide is designed to implement a grating configuration capable of preserving eyebox size while reducing lens size by effectively expanding the exit pupil of a collimating optical system. The exit pupil can be defined as a virtual aperture where the eye may be placed to receive the entire available field of view of the waveguide. As the eye moves beyond the exit pupil, light extracted from the waveguide can still be intercepted by the eye but with a progressively increasing loss of FOV. In some embodiments, the waveguide includes an input grating optically coupled to a light source, a fold grating for providing a first direction beam expansion, and an output grating for providing beam expansion in a second direction, which is typically orthogonal to the first direction, and beam extraction towards the eyebox. As can readily be appreciated, the grating configuration implemented in a waveguide architecture can depend on the specific requirements of a given application. In some embodiments, the grating configuration includes multiple fold gratings. In several embodiments, the grating configuration includes an input grating and a second grating for performing beam expansion and beam extraction simultaneously. The second grating can include gratings of different prescriptions, for propagating different portions of the field-of-view, arranged in separate overlapping grating layers or multiplexed in a single grating layer. Furthermore, various types of gratings and waveguide architectures can also be utilized.

In several embodiments, the gratings within each layer are designed to have different spectral and/or angular responses. For example, in many embodiments, different gratings across different grating layers are overlapped, or multiplexed, to provide an increase in spectral bandwidth. In some embodiments, a full color waveguide is implemented using three grating layers, each designed to operate in a different spectral band (red, green, and blue). In other embodiments, a full color waveguide is implemented using two grating layers, a red-green grating layer and a green-blue grating layer. As can readily be appreciated, such techniques can be implemented similarly for increasing angular bandwidth operation of the waveguide. In addition to the multiplexing of gratings across different grating layers, multiple gratings can be multiplexed within a single grating layer—e.g., multiple gratings can be superimposed within the same volume. In several embodiments, the waveguide includes at least one grating layer having two or more grating prescriptions multiplexed in the same volume. In further embodiments, the waveguide includes two grating layers, each layer having two grating prescriptions multiplexed in the same volume. Multiplexing two or more grating prescriptions within the same volume can be achieved using various fabrication techniques. In a number of embodiments, a multiplexed master grating is utilized with an exposure configuration to form a multiplexed grating. In many embodiments, a multiplexed grating is fabricated by sequentially exposing an optical recording material layer with two or more configurations of exposure light, where each configuration is designed to form a grating prescription. In some embodiments, a multiplexed grating is fabricated by exposing an optical recording material layer by alternating between or among two or more configurations of exposure light, where each configuration is designed to form a grating prescription. As can readily be appreciated, various techniques, including those well known in the art, can be used as appropriate to fabricate multiplexed gratings.

In many embodiments, the waveguide can incorporate at least one of: angle multiplexed gratings, color multiplexed gratings, fold gratings, dual interaction gratings, rolled K-vector gratings, crossed fold gratings, tessellated gratings, chirped gratings, gratings with spatially varying refractive index modulation, gratings having spatially varying grating thickness, gratings having spatially varying average refractive index, gratings with spatially varying refractive index modulation tensors, and gratings having spatially varying average refractive index tensors. In some embodiments, the waveguide can incorporate at least one of: a half wave plate, a quarter wave plate, an anti-reflection coating, a beam splitting layer, an alignment layer, a photochromic back layer for glare reduction, and louvre films for glare reduction. In several embodiments, the waveguide can support gratings providing separate optical paths for different polarizations. In various embodiments, the waveguide can support gratings providing separate optical paths for different spectral bandwidths. In a number of embodiments, the gratings can be HPDLC gratings, switching gratings recorded in HPDLC (such switchable Bragg Gratings), Bragg gratings recorded in holographic photopolymer, or surface relief gratings. In many embodiments, the waveguide operates in a monochrome band. In some embodiments, the waveguide operates in the green band. In several embodiments, waveguide layers operating in different spectral bands such as red, green, and blue (RGB) can be stacked to provide a three-layer waveguiding structure. In further embodiments, the layers are stacked with air gaps between the waveguide layers. In various embodiments, the waveguide layers operate in broader bands such as blue-green and green-red to provide two-waveguide layer solutions. In other embodiments, the gratings are color multiplexed to reduce the number of grating layers. Various types of gratings can be implemented. In some embodiments, at least one grating in each layer is a switchable grating.

Waveguides incorporating optical structures such as those discussed above can be implemented in a variety of different applications, including but not limited to waveguide displays. In various embodiments, the waveguide display is implemented with an eyebox of greater than 10 mm with an eye relief greater than 25 mm. In some embodiments, the waveguide display includes a waveguide with a thickness between 2.0-5.0 mm. In many embodiments, the waveguide display can provide an image field-of-view of at least 50° diagonal. In further embodiments, the waveguide display can provide an image field-of-view of at least 70° diagonal. The waveguide display can employ many different types of picture generation units (PGUs). In several embodiments, the PGU can be a reflective or transmissive spatial light modulator such as a liquid crystal on Silicon (LCoS) panel or a micro electromechanical system (MEMS) panel. In a number of embodiments, the PGU can be an emissive device such as an organic light emitting diode (OLED) panel. In some embodiments, an OLED display can have a luminance greater than 4000 nits and a resolution of 4 k×4 k pixels. In several embodiments, the waveguide can have an optical efficiency greater than 10% such that a greater than 400 nit image luminance can be provided using an OLED display of luminance 4000 nits. Waveguides implementing P-diffracting gratings (e.g., gratings with high efficiency for P-polarized light) typically have a waveguide efficiency of 5%-6.2%. Since P-diffracting or S-diffracting gratings can waste half of the light from an unpolarized source such as an OLED panel, many embodiments are directed towards waveguides capable of providing both S-diffracting and P-diffracting gratings to allow for an increase in the efficiency of the waveguide by up to a factor of two. In some embodiments, the S-diffracting and P-diffracting gratings are implemented in separate overlapping grating layers. Alternatively, a single grating can, under certain conditions, provide high efficiency for both p-polarized and s-polarized light. In several embodiments, the waveguide includes Bragg-like gratings produced by extracting LC from HPDLC gratings, such as those described above, to enable high S and P diffraction efficiency over certain wavelength and angle ranges for suitably chosen values of grating thickness (typically, in the range 2-5 μm).

### Eye Tracking Solutions

Various embodiments in accordance with the invention include a number of eye tracking solutions and methods for measuring eye movement and for implementing eye trackers. In many embodiments, classical eye tracking technology based on projecting IR light into the user's eye and utilizing the primary Purkinje reflections (from the cornea and lens surfaces) and the pupil-masked retina reflection can be implemented. The general strategy is to track the relative motion of these images in order to establish a vector characterizing the point of regard. In some embodiments, eye tracking solutions and methods may track eye movements using just one of the Purkinje reflections. In some embodiments, tracking more than one of the reflections may allow more accurate determination of gaze vectors. The cornea, which has an aspheric shape of smaller radius than the eye-ball, can provide a reflection that tracks fairly well with angular motion until the reflected image falls off the edge of the cornea and onto the sclera. Most solutions rely on projecting IR light into the user's eye and tracking the reflections from the principal surfaces, e.g., at least one surface of the lens, cornea and retina. However, in some cases, there are challenges to introducing the image sensor and illuminator for efficient operation while avoiding obscuring the line of sight. Most eye tracker implementations in HMDs have employed flat beam splitters in front of the users' eyes and relatively large optics to image the reflections onto an imaging sensor. A flat beam splitter may be a substrate inclined at an angle to the user's eye which transmits light towards the eye and allows a portion of the light reflected from the eye to be directed onto a detector (e.g. an imaging sensor). The beam splitter must cover the eye box to intercept all reflected rays and also needs to be far enough from the eye to maintain adequate eye relief (e.g. greater than or equal to 15 mm), particularly if the waveguide-based display includes prescription spectacles. This results in quite a large beam splitter element. From basic geometrical optics, the detector lens which is used to form an image of the tracked feature of the eye on the detector will be of comparable size to the beam splitter. Hence, the beam splitter and lens assembly of this type may have an unacceptable weight and form factor especially for HMDs. Inevitably, there are tradeoffs between exit pupil, field of view, and ergonomics. The exit pupil is generally limited by either the beamsplitter size or the first lens of the imaging optics. In order to maximize the exit pupil, the imaging optics are positioned close to the beamsplitter, presenting vision obscuration and a safety hazard. Another challenge with eye trackers is the field of view, which is generally limited by the illumination scheme in combination with the geometry of the reflected images. The size of the corneal reflected angles would ordinarily require a large angular separation between the illumination and detection optical axes, making using corneal reflections over large FOVs very difficult. Ideally, the eye tracker should minimize the angle between the illumination and reflection beams. The temporal resolution of an eye tracker should be at least 60 Hz. However, 90-120 Hz is preferred. Direct imaging by miniature cameras is becoming more attractive as cameras get smaller, and their resolution increases. However, the latency incurred by the need to recognize and track eye features remains a significant processing bottleneck. From the optical and ergonomic perspective, providing a line-of-sight for a camera in an HMD is not trivial.

In eye tracking applications, the signatures to be recorded do not need to be images of eye features, such as pupil edges, but can be random structures, such as but not limited to speckle patterns (e.g. reflections from multiple surfaces and scatter from the optical media inside the eye). In some examples, the speckle patterns can be a statistic intensity variation arising from non-uniformities in the various eye media and/or surfaces. Alternatively, the speckle patterns may be introduced into the illumination beams to provide a statistical structured light pattern that may be used to track the eye. In many embodiments, the tracked signature has a strong spatio-temporal variation with gaze direction. Such eye trackers in accordance with various embodiments of the invention can be implemented in a variety of configurations. In some embodiments, the eye tracker provides an infrared illumination optical channel for delivering infrared illumination to the eye and an imaging or detection optical channel for forming an image (or recording a signature) of the eye at a detector. The optical channels can be implemented in many different ways, including but not limited to the use of waveguiding structures.

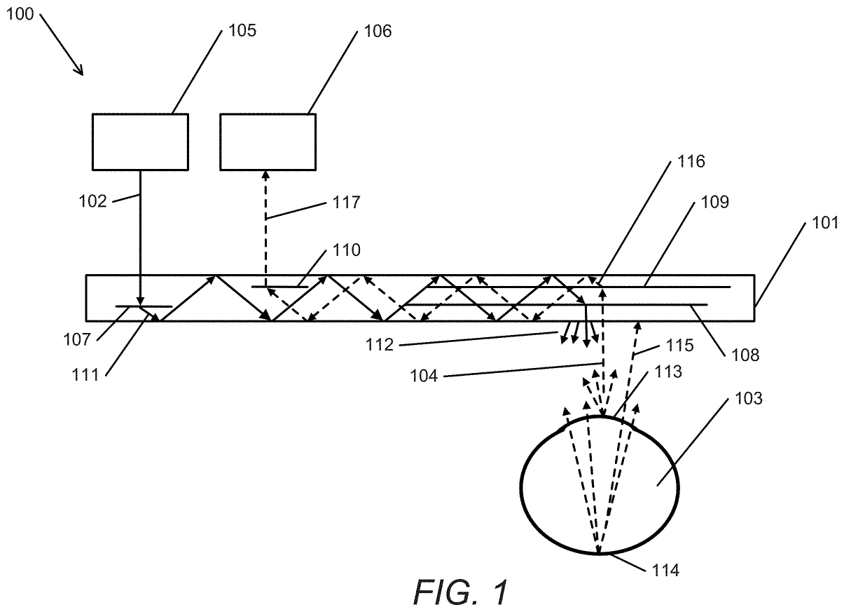

FIG. 1 conceptually illustrates an eye tracker waveguide solution in accordance with an embodiment of the invention. As shown, the eye tracker 100 includes a waveguide 101 for propagating illumination light 102 towards an eye 103 and propagating image light 104 reflected from at least one surface of the eye 103. The illumination light 102 can be patterned light. The eye tracker 100 also includes a light source 105 for providing the illumination light 102 and a detector 106 for receiving the image light 104. The light source 105 and the detector 106 can be optically coupled to the waveguide 101. In the illustrative embodiment, the waveguide 101 includes at least one input grating 107 for deflecting the illumination light 102 from the light source 105 into a first waveguide path within the waveguide 101, at least one illumination grating 108 for deflecting the illumination light 102 towards the eye 103, at least one imaging grating 109 for deflecting the image light 104 into a second waveguide path within the waveguide 101, and at least one output grating 110 for deflecting the image light 104 towards the detector 106. The illumination and imaging gratings 108, 109 can be arrays of switchable beam deflection grating elements, which can be implemented using various grating technologies, including but not limited to SBG technology. Different array designs can be implemented. In some embodiments, the grating elements within the array are elongated, with longer dimension orthogonal to the beam propagation direction. In many embodiments, the elements can have their longer dimensions substantially parallel to the eye vertical axis of rotation. Switchable beam deflection grating elements may provide multiple detection perspectives by switching one or both of the illumination and imaging gratings 108, 109. Each grating may have a k-vector aligned for a particular eye gaze direction. While a passive grating may be used for the illumination and imaging gratings 108, 109, a passive grating will have a lower signal to noise ratio due to the potential for crosstalk between the elements.

In some embodiments, the eye tracker waveguide solution may track the spatial location of the eye box of the user. Typical eye tracker systems may track only the angle of the user's eye in order to provide resolution correction to the user. In some examples, typical eye tracker systems may use the angle of the user's eye to locate the user's gaze. The display may implement a lower resolution image until the eye is fixated along a given direction in which case the display switches to a higher resolution image. However, in these instances, the eye tracker system would not track the spatial location of the eye box of the user. The spatial location of the eye box of the user may be used to provide color or image correction. Without limitation to any particular theory, as the eye rotates from a forward gaze direction, the center of the eye pupil translates spatially producing spatial variation.

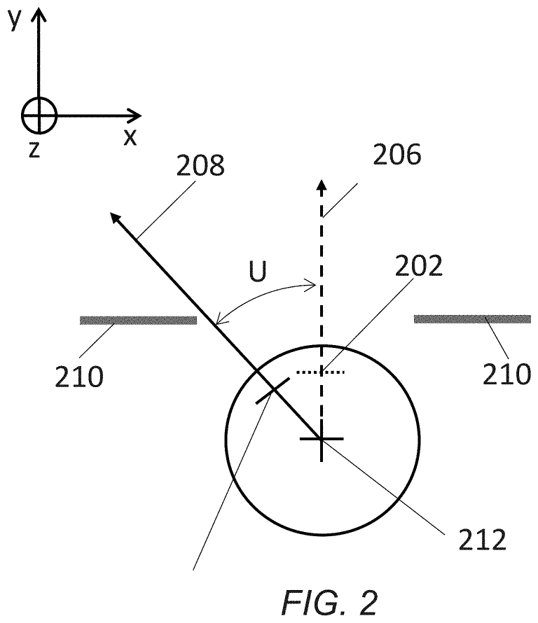

FIG. 2 illustrates an example diagram of eye pupil translation. The initial gaze direction 206 is rotated to create a rotated gaze direction 208 after rotation of the eye through angle U with respect to an eye rotation axis 212. The center of the eye pupil moves from the initial pupil center (x₀, y₀) 202 to a rotated pupil center (x,y) 204 in the plane of the drawing (with reference to the Cartesian reference frame inset into the drawing). Typical eye tracking systems may track only track the rotated gaze direction 208. However, in some embodiments, the position of the eye box 210 may be tracked which may allow for color correction. In some embodiments, the rotated pupil center 204 coordinates may be tracked using the eye tracker which may be used for color correction.

A ‘rainbow’ effect in the waveguide may be caused by this spatial variation. The user's eye rotation may cause pupil translation which may vary the field of color differently with different eye box positions. Correcting for spatial variations in the color uniformity in the eye box may be advantageous. In some embodiments, the spatial variations in the color uniformity may be superimposed on the image which may cause the color to vary as the eye rotates. The perceived variation of color (or luminance and contrast) with angle can vary with position in the eye box. This variation may be a consequence of system aberrations that can arise in the picture generation optics (projection lens) and from the variation of diffraction efficiency with wavelength and angle within the waveguide. The color variation nonuniformity may also be different for the red, green blue components of a color image. Based on the prescriptions of the optical elements along the beam path from the microdisplay panel to the eyebox, the resulting spatial values of color nonuniformity at points in the eyebox can be determined using ray tracing. From basic colorimetry theory, the tristimulus values (which specify a color's lightness, hue and saturation, from which the chromaticity coordinates may be computed) the adjustment to bring the RGB chromaticity coordinates on target at each pupil point and for each viewing direction can be calculated. In some embodiments, this calculation can be performed in real-time following each gaze vector and pupil position update from the eye tracker. In many embodiments, it may be more computationally efficient to determine the complete set of color coordinate adjustments for each pupil position and viewing direction in an initial calibration of the eye tracker, the adjustments being stored in a look-up table (LUT). A separate LUT can be provided for each of the red, green and blue color components, with the corrections for each angular direction being applied to individual pixels of the microdisplay. In some embodiments, the corrections can be computed for submatrices of the input image pixel array using eye tracker data sampled at lower angular and spatial frequencies. The correction for individual pixels can then be obtained using interpolation. This procedure can avoid the processing latency that may result from having to perform colorimetric calculations in real-time. In some embodiments, predictive eye tracking algorithms can be used in association with color correction to reduce latency. Various criteria can be used to characterize color correction. For example, one criteria may be based on adjusting the viewed image white point variation across the field of view to some predefined range of values. Another approach may involve adjusting color space parameters to achieve some predefined color gamut variation across the field of view.

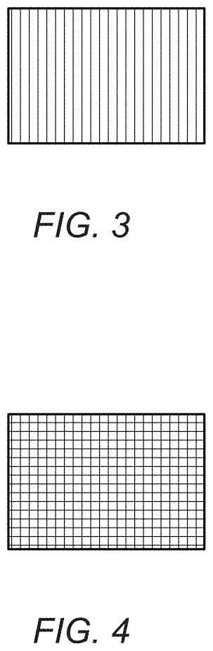

FIG. 3 illustrates one such embodiment. Another configuration, such as the one illustrated in FIG. 4, includes grating elements disposed in a two-dimensional array, where each element can be configured to have optical power in two orthogonal planes. The embodiment disclosed in connection with FIG. 1 may image the surface of the user's eye using the detector 106 where the detector is an imaging detector array. Thus, the illumination and imaging gratings 108, 109 may include optical power. In some embodiments, the illumination and imaging gratings 108, 109 may be plane gratings without optical power. In instances where this is true, the detector 106 may be a low resolution 1D or 2D array device or a single element detector. The detector 106 may record a signature that varies with eye gaze direction. The signature may be statistical in nature, for example, a speckle pattern as discussed below. In some embodiments the signature may have some other type of spatial-temporal variation that may be compared with values stored in a look-up table populated using measurements recorded in a preliminary calibration of the eye tracker.

Referring back to FIG. 1, the general light path during operation of the eye tracker is the combination of the first and second waveguide paths—e.g., the imaging and illumination paths in the waveguide. In the illustrative embodiment, the two paths are in opposing directions. The illumination light will typically be fully collimated while the image light will have some divergence of angle determined by the scattering properties of the tracked eye surfaces, the angular bandwidth of the gratings, and the numerical aperture of the grating elements. Although FIG. 1 illustrates the gratings as disposed within a single waveguide structure, many different waveguide and grating architectures can be implemented. In some embodiments, the imaging and illumination gratings are provided by a single grating with the illumination and imaging ray paths counter-propagating in the same waveguiding structure. In several embodiments, the illumination and imaging gratings 108, 109 are in separate grating layers. In a number of embodiments, the input and illumination gratings 107, 108 are in a first grating layer while the output and imaging gratings 109, 110 are in a second grating layer. In further embodiments, each of the separate grating layers is sandwiched by substrates, forming two distinct waveguiding structures. Where separate illumination and imaging gratings 108, 109 are used, the two gratings can respond to different TIR angle ranges within the waveguide(s). This can be advantageous in terms of avoiding the risk of cross-coupling of illumination light into the detector and image light into the light source.

In FIG. 1, the illumination light path begins with light rays 102 emitted from the light source 105, which is directed into a TIR path 111 by the input grating 107. In many embodiments, the light source 105 is a laser emitting in the infrared band. The choice of wavelength can depend on laser efficiency, signal to noise, eye safety, and other considerations. Light Emitting Diodes (LEDs) can also be used. The light continues to propagate within the waveguide 101 and is diffracted out of the waveguide 101 by the illumination grating 108, where the illumination rays are generally indicated by light rays 112. In the illustrative embodiment of FIG. 1, the illumination grating 108 provides divergent light. In other embodiments, the illumination grating 108 provides collimated light. Typically, the eye tracker 100 will have a pupil of size 20-30 mm. to allow the capture of light reflected from the eye 103 to continue should the waveguide 101 change position relative to the eye 103. In embodiments where the eye tracker 100 will be implemented as part of an HMD, its pupil should desirably match that of the HMD.

The output rays 112 are reflected off the front surface of the cornea 113 and the retina 114 as return light 104 and 115, respectively. The corneal and retinal image light can be coupled back into the waveguide 101 by an active element of the imaging grating 109, which can be switched one element at a time, into a TIR path, illustrated by rays such as 116. The light 116 is deflected into a ray path 117 toward the detector 106 by the output grating 110, which can be switched one element at a time. In some embodiments, the detector 106 is a two-dimensional array detector. Other types of detectors can also be used. For example, linear arrays and analogue devices such as but not limited to position sensing detectors can be used. In many embodiments, the detector 106 reads out the image signal in synchronism with the switching of the elements. The detector 106 can be connected to an image processing apparatus for determining at least one spatio-temporal characteristic of an eye movement. The image processor, which is not illustrated, can detect pre-defined features of the backscattered signals from the cornea and retina. For example, the image processor may be used to determine the centroid of an eye feature such as the pupil. Other trackable features of the eye will be well known to those skilled in arts of eye tracker design and visual optics.

Although FIG. 1 illustrates a specific eye tracking solution, various configurations and architectures can be implemented for eye tracking as appropriate depending on the specific requirements of a given application. For example, various grating structures and waveguide architectures in addition to those shown in FIG. 1 can be implemented. The gratings may be implemented as lamina within or adjacent an external surface of the waveguide. In other words, the grating may be disposed adjacent an optical surface of the waveguide, which can include at least one of an internal surface or an external surface of the waveguide. For the purposes of discussing the invention, we will consider Bragg gratings disposed within the waveguide. Advantageously, the gratings may be switchable Bragg gratings (SBGs). In several embodiments, the gratings are reverse mode SBGs. In some embodiments, passive gratings may be used. Furthermore, SBGs can also be used as passive gratings. However, passive gratings can lack the advantage of being able to direct illumination and collect image light from precisely defined areas of the pupil. Further, using switchable gratings allows greater versatility in the capture of eye signals. For example, gratings with different k-vectors can be used to provide different illumination angles and/or detection angles to allow eye gaze directions to be tracked from multiple perspectives. This ensures high signal to noise ratio (SNR) across the entire tracked field of view. A passive grating may only allow a single perspective which may only provide high SNR around one gaze direction. Switchable gratings may also allow the tracking of vertical and horizontal eye displacements in isolation from each other, eliminating crosstalk and increasing SNR.

The gratings may be surface relief gratings. However, such gratings may be inferior to Bragg gratings in terms of their optical efficiency and angular/wavelength selectivity. Although the invention is discussed in relation to transmission gratings, it should be apparent to those skilled in the art that equivalent embodiments using reflection gratings can also be implemented.

### Real-Time Color Correction for Waveguide Applications

In addressing the color non-uniformity problem with respect to waveguide applications, different systems and methods can be implemented as appropriate depending on the specific requirements of a given application. Color non-uniformity can arise from various sources. For example, in full-color RGB waveguides, one possible source results from non-matching, non-uniform profiles for each of the red, green, and blue outputs. The superimposition of the three output forms an output profile that is spectrally non-uniform. In principle, color non-uniformity can be pre-compensated or pre-corrected for during processing by altering the values and characteristics of the input image light such that any effect or transformation performed by the gratings will result in the desired original image. For example, in full-color RGB waveguides, the proportions of red, green, and blue light in the original image light can be altered such that the effects of the gratings on the final output image are compensated. However, in many cases, color non-uniformity profiles can vary based on the position of the user's pupil and/or the angle at which the user views the image. Such variations can be difficult or impossible to correct for across all viewing conditions during processing. One class of alternative solutions includes performing corrections in real-time based on the user's viewing condition. In such embodiments, a system can be implemented with sensors to determine the user's viewing condition, which the system can then utilize to perform the appropriate color correction to the input image light in order to mitigate color non-uniformity in the output.

Real-time color correction processes in accordance with various embodiments of the invention can be implemented with a variety of different systems. In many embodiments, the system is implemented as a waveguide display and includes an optical engine, a waveguide, and at least one eye tracker. Optical engines can include various illumination schemes. In some embodiments, the optical engine includes a compact laser illumination delivery solution. In other embodiments, the optical engine implements LED illumination. In several embodiments, the optical engine includes a PGU. Utilizing information from the eye tracker, the system can be configured to determine the alterations to the input image light required to achieve the desired compensation. In such embodiments, the system can include a controller or electronics for processing information from the eye tracker to provide a signal to the optical engine relating to the appropriate corrections needed to be made.

FIG. 4 conceptually illustrates a schematic of a waveguide display implementing real-time color correction in accordance with an embodiment of the invention. In the illustrative embodiment, the waveguide display 400 includes an optical engine 401, a first waveguide 402, and a second waveguide 403 implemented as an eye tracker waveguide. As shown, the optical engine 401 is configured to provide a light source to illuminate the first waveguide 402 (as shown by ray 404). The first waveguide 402 is configured to redirect, expand, and output the light (as shown by rays 405, 406). Although FIG. 4 shows the first waveguide 402 and the eye tracker waveguide 403 as being disposed in contact with one another, the two waveguides 402, 403 can be separated by an air gap or by a low refractive material. The waveguide display 400 further includes an source 407 and an detector 408 for implementing eye tracking. The optical path from the source 407 to the user's eye 409 is indicated by rays 410-412. The eye tracker waveguide 403 is configured to receive and redirect the backscattered signal 413 towards the infrared detector 408 (as shown by ray 414). To implement real-time color correction, the detector 408 can be coupled to a controller 415. During operation, the detector 408 is configured to transmit information regarding the user's viewing condition to the controller 415. The source 407 and the detector 408 may emit and detect sources of radiation such as infrared radiation, UV light, or visible light. As discussed above, the user's viewing condition can be determined through analysis of the backscattered signal 413 using a variety of different methods. The detector 408 may include a detector signal processor coupled to the detector 408. The detector signal processor may compute the eye gaze direction vector and the eye pupil coordinates form the detected backscattered signal 413. The detector signal processor may track the spatial location of the eye box of the user. The detector signal processor may be configured to pass the viewing condition information to a light source controller 415. The controller 415 can then transmit appropriate signals to the optical engine 401 to provide instructions regarding the required compensation based on the viewing condition information. The controller 415 may include a lookup table which may correlate different gaze directions and pupil coordinates of the user's eye with different image compensation factors to be applied to the optical engine 401. As can readily be appreciated, various systems of different configurations can be implemented as appropriate depending on the specific requirements of a given application. In many embodiments, the controller is integrated with the optical engine or eye tracker apparatus. Various hardware and software eye-tracker solutions can be utilized. In several embodiments, non-waveguide eye tracker solutions are implemented. In some embodiments, the waveguide display is implemented as a binocular eyeglasses design. In several embodiments, two eye trackers are implemented. In further embodiments, two eye trackers are implemented for each of the user's eyes.

In some embodiments, the infrared detector 408 and/or controller 415 may track the spatial location of the eye box of the user. Typical eye tracker systems may track only the angle of the user's eye in order to provide resolution correction to the user. In some examples, typical eye tracker systems may use the angle of the user's eye to locate the user's gaze. The display may implement a lower resolution image until the eye fixates along a given viewing direction in which case the display switches to a higher resolution image. However, in these instances, the eye tracker system would not track the spatial location of the eye box of the user. In some embodiments, the controller 415 may use the spatial location of the eye box of the user to provide color or image correction. Without limitation to any particular theory, as the eye rotates from a forward gaze direction, the eye translates spatially producing spatial variation. A ‘rainbow’ effect in the waveguide may be caused by this spatial variation. The user's eye rotation may cause pupil translation which may vary the field of color differently with different eye box positions. Correcting for spatial variations in the color uniformity in the eye box may be advantageous. In some embodiments, the spatial variations in the color uniformity may be superimposed on the image which may cause the color to vary as the eye rotates.

As discussed above, information from the eye tracker can be utilized to determine in real-time the compensations to be performed to the input image light. In some embodiments, information from the eye tracker is used to determine the user's viewing condition. Information capable of determining the user's viewing condition can include but are not limited to eye relief information, location of the user's gaze, location of the eye relative to the user's head, waveguide, eye tracker, or any other known object, and location of features (pupil, iris, etc.) of the user's eye. Depending on the user's viewing condition, the system can perform the appropriate compensation to the input image light accordingly. In a number of embodiments, the compensation is performed by configuring the optical engine to output the desired, compensated light. In some embodiments, an electrically controllable component is implemented to modify the light outputted from the optical engine to perform the desired compensation. The rate at which compensations and corrections are performed can be limited by several factors, including but not limited to mechanical or technical limitations of the system. In some cases, the compensations are performed at a rate proportional to the sampling rate of the eye tracker implementation. In several embodiments, the rate at which the compensations are performed is limited by the computational power of the system. As can readily be appreciated, the rates at which compensations are performed can vary and can depend on the specific requirements of a given application.

In many embodiments, information from the eye tracker is used in conjunction with a lookup table to control the output of the optical engine—e.g., the input image light. In such embodiments, the process implemented can include a pre-calibration step to map out and determine the waveguide's characteristics and transformation effects on the input light. The information from the pre-calibration step can be utilized to create a lookup table detailing the compensations necessary for a given viewing condition for a given waveguide. As can readily be appreciated, a lookup table can be formed for and associated to each individual waveguide. In many embodiments, the lookup table includes a finite list of viewing conditions. Such embodiments can be implemented by discretizing and classifying all possible viewing conditions using a predetermined rule. For example, each possible viewing conditions can be associated with its most comparable (as characterized and identified by a predetermined rule) viewing condition within the finite list. As can readily be appreciated, the classification and discretization process can be implemented as appropriate depending on the specific requirements of a given application.

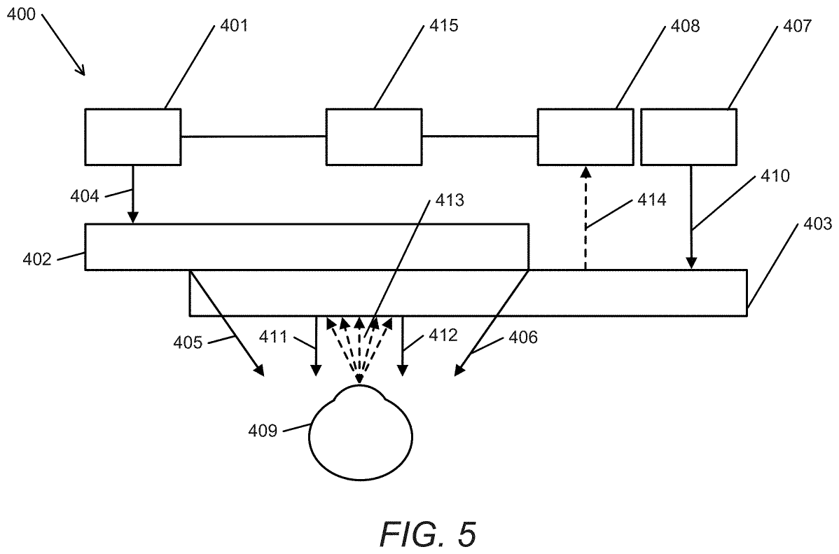

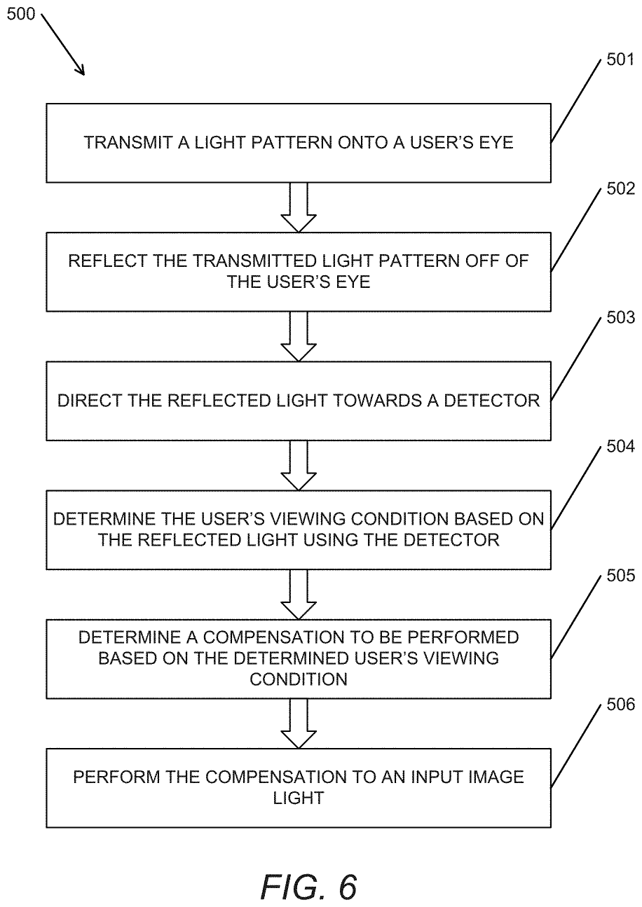

FIG. 5 is a flow chart conceptually illustrating a process for real-time color correction for waveguide applications in accordance with an embodiment of the invention. The real-time color correction may use eye tracker information to pre-compensate the input image to provide uniform color and brightness across the eye box in all directions. In some embodiments, the compensation adjustment may be based on a look-up table measured in an initial calibration procedure. In some embodiments, the compensation adjustment may be dynamically performed. As shown, the method 500 includes transmitting (501) a light pattern onto a user's eye. The light pattern can be reflected (502) off of a feature of the user's eye—e.g., lens, cornea, and/or retina. The reflected light can be directed (503) towards a detector. A user's viewing condition can be determined (504) using information from the reflected light. The user's viewing condition can include but are not limited to eye relief information, location of the user's gaze, location of the eye relative to the user's head, waveguide, eye tracker, or any other known object, and location of features (pupil, iris, etc.) of the user's eye. In some embodiments, the user's viewing condition may include the spatial location of the eye box of the user. Typical eye tracker systems may track only the angle of the user's eye in order to provide resolution correction to the user. In some examples, typical eye tracker systems may use the angle of the user's eye to locate the user's gaze. The display may implement a lower resolution image until the eye fixates along a given viewing direction in which case the display switches to a higher resolution image. However, in these instances, the eye tracker system would not track the spatial location of the eye box of the user. In some embodiments, the spatial location of the eye box of the user may be used to provide color or image correction. Without limitation to any particular theory, as the eye rotates from a forward gaze direction, the eye translates spatially producing spatial variation. A ‘rainbow’ effect in the waveguide may be caused by this spatial variation. The user's eye rotation may cause pupil translation which may vary the field of color differently with different eye box positions. Correcting for spatial variations in the color uniformity in the eye box may be advantageous. In some embodiments, the spatial variations in the color uniformity may be superimposed on the image which may cause the color to vary as the eye rotates.

A compensation factor can be determined (505) using the user's viewing condition. The compensation factor may include a color correction or an image correction as described above. As described above, the compensations to be made on the input image can be determined using a variety of different methods, including but not limited to the use of a lookup table in conjunction with the viewing condition information. The determined compensation can be applied (506) to an input image light. In many implementations, the compensations are applied to input image light originating from an optical engine. Light sources used in the optical engine can include but are not limited to laser and LED sources. In some display applications, the compensated input image light is directed towards and coupled into a waveguide for propagation towards a user's eye. As can readily be appreciated, the compensations can be determined and applied at a predetermined frequency that can depend on a number of factors, including but not limited to the operating frequency of the detector. For example, many embodiments of the invention are capable of performing the compensations at frequencies of up to 120 Hz. In many embodiments, the compensations are performed at a frequency of 60 Hz. In some embodiments, the compensations are performed at 90 Hz.

Although FIG. 5 illustrates a specific method for real-time color correction, various different processes can be implemented to perform such functions. For example, both waveguide-based and non-waveguide based eyetrackers can implemented to determine the user's viewing condition. Eye features and illumination patterns utilized to determine the viewing condition can also vary. Compensations to the input image light can be modification to the intensity of at least one of red, green, or blue light in RGB applications.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A color correction system comprising:
an eye tracker system; and
an optical engine controller in communication with the eye tracker system and an optical engine,
wherein the eye tracker system is configured to compute eye gaze direction vectors and eye pupil coordinates, and
wherein the optical engine controller is configured to compute a compensation factor based on the eye gaze direction vectors and the eye pupil coordinates.

2. The color correction system of claim 1, wherein the eye tracker system comprises:
a light source;
a detector;
a waveguide comprising:
an input grating to inputting illumination light from the light source into the waveguide;
an illumination grating for deflecting the illumination light towards an eye;
an detector grating to input illumination light reflected off the eye into the waveguide; and
an output grating for outputting the reflected illumination light from the waveguide into the detector,
wherein the detector is configured to compute the eye gaze direction vectors and the eye pupil coordinates based on reflected illumination light.

3. The color correction system of claim 2, wherein the illumination grating and/or the imaging grating comprises an array of switchable beam deflection grating elements.

4. The color correction system of claim 3, wherein the array of switchable beam deflection grating elements comprises grating elements elongated with a longer dimension orthogonal to a beam propagation direction of the illumination light.

5. The color correction system of claim 3, wherein the array of switchable beam deflection grating elements comprises grating elements disposed in a two-dimensional array.

6. The color correction system of claim 5, wherein each grating element is configured to have optical power in two orthogonal planes.

7. The color correction system of claim 2, wherein the illumination grating and the imaging grating comprises a single grating configured to both deflect the illumination light towards the eye and input illumination light reflected off the eye into the waveguide.

8. The color correction system of claim 2, wherein the illumination grating and the imaging grating comprise separate gratings in separate layers.

9. The color correction system of claim 2, wherein the illumination grating and the input grating are in a first grating layer and the imaging grating and the output grating are in a second grating layer.

10. The color correction system of claim 9, wherein the first grating layer and second grating layer are separate grating layers and are each sandwiched by substrate forming two distinct waveguiding structures.

11. The color correction system of claim 2, wherein the illumination grating and the imaging grating respond to different total internal reflection angle ranges within the waveguide.

12. The color correction system of claim 2, wherein the illumination light is reflected off the front surface of the cornea, the lens, and/or the retina of the eye.

13. The color correction system of claim 2, wherein the illumination light comprises infrared light.

14. The color correction system of claim 1, wherein the optical engine controller uses a look-up table to compute the compensation factor.

15. The color correction system of claim 14, wherein the look-up table correlates different gaze directions and pupil coordinates of the user's eye with different image compensation factors.

16. The color correction system of claim 1, wherein the compensation factor comprises color correction or image correction.

17. The color correction system of claim 2, wherein the detector comprises a detector signal processor which is configured to compute the eye gaze direction vectors and the eye pupil coordinates from the detected illumination light.

18. A waveguide-based display comprising:
the color correction system of claim 2; and
another waveguide configured to accept light from the optical engine and output the light into the user's eye.

19. The waveguide-based display of claim 18, wherein the waveguide and the other waveguide are in contact with each other.

20. The waveguide-based display of claim 18, wherein the waveguide and the other waveguide are separated by an air gap or a low reflective material.

21. A method of providing real-time color correction for a waveguide based display, the method comprising:
transmitting a light pattern onto a user's eye;
reflecting the light pattern off of a feature of the user's eye;
directing the reflected light pattern towards a detector to produce eye tracking information, wherein the eye tracking information comprises eye gaze direction vectors and eye pupil coordinates;
determining the user's viewing condition based on the eye tracking information;
based on the determined viewing condition, applying a compensation factor to an input image light.

22. The method of claim 21, wherein the feature of the user's eye comprises the lens, the cornea, or the retina of the user's eye.

23. The method of claim 21, wherein compensation factor comprises compensation to an input image to a waveguide.

24. The method of claim 21, wherein the compensation factor is used to alter an input image originating from an optical engine.

25. The method of claim 21, wherein the compensation factor is applied with frequency that is equal to or less than the operating frequency of the detector.

26. The method of claim 21, wherein the compensation factor includes color correction or image correction.
